(19) United States
(12) Patent Application Publication
(10) Pub. No.: US 2016/0092852 A1
(43) Pub. Date: Mar. 31, 2016

(54) ALLOCATION AND DISTRIBUTION OF PAYMENT FOR PODCAST SERVICES

(71) Applicant: Apple Inc., Cupertino, CA (US)

(72) Inventors: James O. Boggs, San Francisco, CA (US); Ryan Griggs, Palo Alto, CA (US)

(21) Appl. No.: 14/502,188

(22) Filed: Sep. 30, 2014

(51) Int. Cl. G06Q 20/10; G06Q 30/02; G06Q 20/12

(52) U.S. Cl. CPC G06Q 20/10; G06Q 20/123; G06Q 30/0279; G06Q 30/0282

(57) ABSTRACT

Methods and arrangements are provided for podcast listeners to allocate and distribute payments to podcast content creators based on their engagement and enjoyment of the podcasts. An allocation system provides for monitoring of engagement metrics of listeners, including such metrics as percent of podcast consumed, frequency of consumption, whether the podcast is regularly listened to during a daily commute, and other signs of engagement with the content. Listeners provide a donation budget to the allocation system, representing the total amount of donation for all podcasts listened to. The allocation system then allocates a portion of the donation budget to each podcast according to the level of engagement represented by the engagement metrics that are monitored.

### TECHNICAL FIELD

The present technology pertains to podcast media services, and more specifically pertains to a payment allocation and distribution mechanism to facilitate donations to providers of podcast services.

### BACKGROUND

There are more varieties of digital media experiences today than ever before. Many avenues for receiving and enjoying digital media content exist, including online media download applications, streaming services, and more. In addition, users are increasingly experiencing digital media through on-the-go devices such as portable media players, phones, tablets, and portable game consoles. One popular form of experiencing digital media content is the podcast. A podcast is a series of audio, video or document files in a concise form, like an .mp3, .pdf, .wma or .mpeg file, wrapped in descriptive metadata with a cover art image. Podcasts are often created in the format of a radio or television show. Users “subscribe” to a podcast so that new episodes can be streamed or automatically downloaded and delivered to a media player, like an iPod (from which the term “pod” originates). The file can then be experienced at the user's convenience, such as during a commute to work.

Content providers are increasingly turning to podcasting as an inexpensive, user-friendly, and popular distribution channel that has the potential to reach a huge audience. Many varieties of content appear and have the opportunity for establishing a large viewership, from small individual podcasters to major newspapers and other print media. Currently, podcasts can generally be subscribed to and received from a podcasting application without the podcasting application negotiating any fee payments between a user and a podcast provider. Some content providers will set up a “pay for consumption” model, with a transaction occurring outside of the podcasting application. Others will have indirect sponsorship and advertising content within the podcast. A third monetization strategy is donation, similar to the fundraising efforts of traditional public broadcasting. This will also occur outside of the podcasting application, and will often involve a user calling in to make a pledge, followed by completing the transaction via mail or email, as in traditional fundraising methods.

While podcast donation and fundraiser efforts are valid ways of seeking user contributions, so far they have shown low rates of contribution, due to the cumbersome traditional fundraising methods that have been employed. While podcast subscription and playback have been optimized to take advantage of modern ways of media consumption with their user-friendliness, standardization and portability, podcast monetization efforts are often not successful in part because they lack the same ease of use.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, devices, and non-transitory computer-readable storage media for allocating a user budget and sending monetary donations to providers of podcast content within a podcast services engine. Podcasts are a type of media content that can be easily shared and distributed via a podcasting platform, such as a mobile application that connects to a cloud or server to receive podcast content. While podcasts are typically audio, they may also take the form of documents, graphics, audio, video, or interactive content. Podcast listeners “subscribe” to a podcast, meaning they elect to periodically receive streamed or downloaded podcast episodes which are accessible via their user device. In this way, multiple podcast episodes can accrue on a user device for ease of access and playback. The efficient dissemination of podcasts means that they are often ideal for portable devices, commutes, and daily, weekly or monthly listening. A cloud-based library of podcasts can communicate with one or more devices via a network. Any user device with a wired network connection, Wi-Fi connection, Bluetooth, or other form of connection to a network can communicate with such a library and exchange information. Content can be synchronized between the user device and the cloud, cache content for efficient usage and storage of that content, and manage content both on the cloud and on the devices.

Monetizing podcasts can be accomplished by allowing for users to specify, in differing embodiments, a one-time or recurring budget which is allocated for making donations or payments to content providers of podcasts. A budget can be refreshed on a monthly basis, for example, thus providing a monthly fund for payment to podcast providers. User engagement is monitored and recorded in a series of one or more engagement metrics. Such engagement metrics may include, in differing embodiments, length of consumption, frequency of consumption, location and route of the user while listening, user reviews and ratings, and more.

User engagement metrics are used to determine rankings of podcasts consumed. The rankings specify the podcasts which have the most positive user interaction and engagement relative to other podcasts. A budget can then be allocated for each podcast according to the rankings. In some embodiments, users are notified of the allocation and presented with statistics of their usage and allocation. In additional embodiments, content providers are provided with anonymized or aggregate information pertaining to user demographics, location, engagement metrics and more.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates an exemplary method embodiment;

FIG. 3A and FIG. 3B illustrate exemplary interface embodiments presented on a user device; and

FIG. 4A and FIG. 4B illustrate exemplary system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for an improved means of allocating and distributing funds to podcast content providers. The disclosed technology provides users with a method of setting up both one-time and recurring payments to podcasts that the user has engaged with, and allocates the funds according to how much the user has engaged with each podcast. The disclosed technology also providers content providers with a means to receive funds for podcasts from users without manually setting up a fundraising initiative on their own.

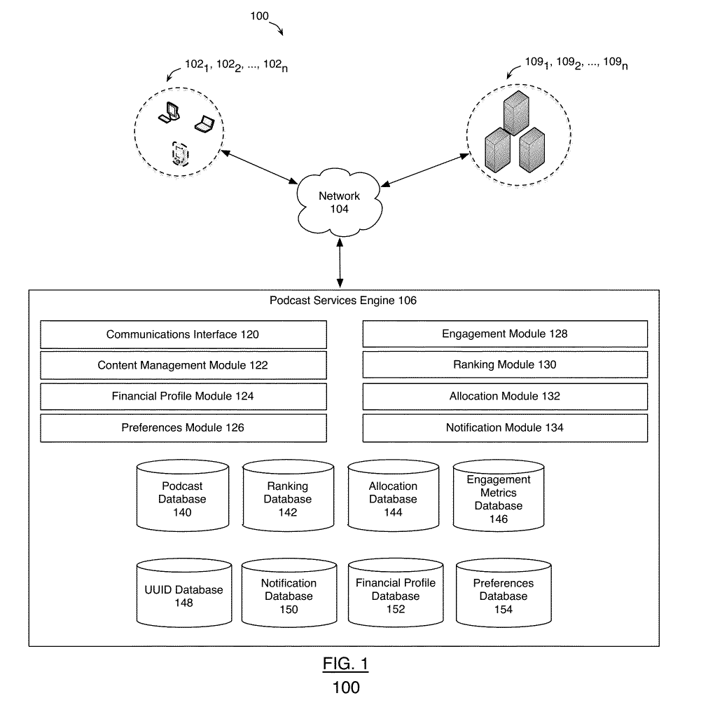

An exemplary system configuration 100 is illustrated in FIG. 1, wherein electronic devices communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, podcast content can be delivered to user terminals 102₁, 102₂, . . . , 102ₙ (collectively “102”) connected to a network 104 by direct and/or indirect communications with a podcast services engine 106. User terminals 102 can be any network enabled client devices, such as desktop computers; mobile computers; handheld communications devices, e.g. mobile phones, smart phones, tablets; smart televisions; set-top boxes; and/or any other network enabled computing devices. Furthermore, podcast services engine 106 can concurrently accept connections from and interact with multiple user terminals 102.

The podcast services engine 106 can receive a request for electronic content, such as a podcast media item, etc., from one of user terminals 102. Thereafter, the podcast services engine 106 can assemble a podcast content package and transmit the assembled content to the requesting one of user terminals 102. To facilitate communications with the user terminals 102 and/or any other device or component, the podcast services engine 106 can include a communications interface 120.

The podcast services engine 106 can include a content management module 122 to facilitate the generation of an assembled podcast content package. Specifically, the content management module 122 can use content from one or more content providers 109₁, 109₂, . . . , 109ₙ (collectively “109”) to generate the assembled podcast content package for the user terminals 102. For example, in the case of a podcast episode being delivered to a requesting one of user terminals 102, the content management module 122 can assemble a podcast content package by requesting the data for the podcast episode from one of the primary content providers 109 maintaining the podcast. However, the content package is not limited to the content from content providers 109. Rather, the content package can include other data generated at the podcast services engine 106. In some embodiments, the podcast services engine 106 can preselect the content package before a request is received.

An assembled podcast content package in the preferred embodiment consists of audio, but in differing embodiments can include audio, text, graphics, video, executable code, or any combination thereof. In some embodiments, the podcast content can be associated with a product or can directly or indirectly advertise a product. For example, the assembled content package can include one or more types of advertisements from one or more advertisers.

Additionally, the podcast content can be active podcast content. That is, podcast content that is designed to primarily elicit a pre-defined response from a user. For example, active podcast content can include one or more types of advertisements configured to solicit information or be converted by the user into a further action, such as a purchase or a download of the advertised item. However, podcast content can also be passive podcast content. That is, podcast content that is designed to primarily inform the user, such as audio. In some cases, passive podcast content can include information that can lead or direct users to other podcast content including active podcast content.

Furthermore, the podcast content can be dynamic podcast content. That is, podcast content that varies over time or that varies based on user interaction. For example, dynamic podcast content can include an interactive game. However, the various embodiments are not limited in this regard and the podcast content can include static podcast content that neither varies over time nor with user interaction. In the various embodiments, podcast content in a content package can be static or dynamic and active or passive. A content package can include a combination of various types of podcast content in a single content package.

In some cases, a content package can replace or update podcast content in a content package already delivered to a user terminal. For example, a first content package can include an app that can be installed on the user terminal 102ᵢ. A subsequent content package can include one or more items of podcast content that can be presented to a user of the user terminal 102ᵢ while the user interacts with the app.

The content management module 122 can be configured to request that content be sent directly from content providers 109. Alternatively, a cached arrangement can also be used to improve performance of the podcast services engine 106 and improve overall user experience. That is, the podcast services engine 106 can include a podcast database 140 for locally storing/caching content maintained by content providers 109. The data in the podcast database 140 can be refreshed or updated on a regular basis to ensure that the content in the database 150 is up to date at the time of a request from a user terminal 102ᵢ. However, in some cases, the content management module 122 can be configured to retrieve content directly from content provider 109 if the metadata associated with the data in the podcast database 140 appears to be outdated or corrupted.

In the various embodiments, the podcast services engine 106 can also include a unique user identifier (UUID) database 148 that can be used for managing sessions with the various user terminal devices 102. The UUID database 148 can be used with a variety of session management techniques. For example, the podcast services engine 106 can implement an HTTP cookie or any other conventional session management method (e.g., IP address tracking, URL query strings, hidden form fields, window name tracking, authentication methods, and local shared objects) for user terminals 102 connected to podcast services engine 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 148. The podcast services engine 106 can analyze the attributes of requesting devices to determine whether such requests can be attributed to the same device. Such attributes can include device or group-specific attributes.

In some embodiments, the podcast services engine 106 can include a financial profile database 152. The financial profile database 152 can, at least in part, be constructed based on declared financial characteristics related to one or more users. In some cases, the financial profile database may contain inferred or derived financial characteristic values. The financial profile database includes payment information for users, such as credit card information, or online payment service information such as PayPal account information, within a secured, encrypted format.

The financial profile module 124 allows for financial information to be created and stored within the financial profile database 152, updated, and removed from the financial profile database 152. The financial profile module 124 allows users to manually create a financial profile by inputting payment information, billing address and other pieces of payment information via a secure input interface. Once the financial information is inputted, it can be encrypted and stored within the financial profile database 152. The financial profile module 124 also allows users to edit an existing financial profile, as well as to remove financial information from the financial profile database.

A preferences module 126 stores user preferences regarding podcast playback, engagement, ranking and allocation within the preferences database 154. A user may be prompted via a user interface to enter preferences relating to the entire podcast experience and to the allocation and processing of donations. In some embodiments, users may elect the preference to rank podcasts themselves rather than the podcast services engine 106 forcing a ranking of podcasts. Users may also allocate a specific amount of funds to podcasts instead of agreeing or disagreeing to an automatically determined allocation. In some embodiments, users may have the preference of disabling or blacklisting certain podcasts from being ranked and allocated funds. In some embodiments, users may be given granular options for controlling the amount and kind of monitoring and session activity tracking performed by the podcast services engine 106.

The podcast services engine 106 contains an engagement module 128 which tracks user engagement with podcast content. The purpose of the engagement module 128 is to actively monitor a user's activity, interaction and engagement with the podcast content that the user accesses via the podcast services engine 106. A series of engagement metrics are stored within the engagement metrics database 146. Engagement metrics can include one or more of a variety of different metrics which track a user's engagement and interest in the podcast content that a user consumes.

In one embodiment, an engagement metric can be the total number of minutes consumed by the user for a given piece of podcast content. For example, if a user plays half the length podcast on the user's playback device via the user terminal 102, then the engagement module 128 opens a monitoring session when the user first begins playing back the podcast content, and when the user stops the podcast, then the engagement module 128 records the length of the playback session within an engagement metric file designating the total minutes consumed for the given piece of podcast content. This engagement metric file is stored within the engagement metrics database 146 for later use. In some embodiments, percentage of the media item consumed is an engagement metric rather than, or in addition to, total length consumed.

In some embodiments, frequency of consumption is another example of an engagement metric that the engagement module 128 tracks. Each time a podcast in a series from a content provider is played back on the user's device, the engagement module 128 updates a file with the frequency of consumption for that podcast for that user. If a user regularly listens to a specific podcast every day or every week, then the frequency of consumption will register as a high number compared to a podcast that a user rarely listens to. For example, a user may make it a point to listen to a specific podcast every day at 10 PM. Both the frequency of the podcast playback and the consistent time factor in to indicate a particular user engagement with respect to that podcast. Time since a podcast was last listened to is also considered in some embodiments. For example, if one podcast was last listened to three months ago, the user will not have as high of an engagement on this metric for that podcast compared to a podcast that was last listened to a week ago, even if the former podcast is listened to more times than the latter podcast. Different weights for frequency of consumption are capable of being accorded to users and podcasts depending on ranking rules and how engagement metrics are assigned.

A third example of engagement metric is location of consumption. In some embodiments, the user terminal 102 is capable of sending information to the podcast services engine 106 regarding the location of the user terminal 102. One example of communicating the location of user terminal 102 is GPS technology. In some embodiments the user must opt-in to communicate the location of the user terminal 102. The engagement module 128 opens a background location session while a user is playing back a podcast. In some embodiments the location session monitors the location of the user terminal 102 periodically, while in other embodiments, the location session monitors the route of the user terminal 102 over time. By comparing the location and/or route of the session to previous sessions, the engagement module 128 learns whether a user is commonly listening to a podcast in a particular location, as well as whether a user is commonly listening to a podcast during a particular journey to a destination. Signs that a user frequently listens to a podcast in a specific place are taken as positive user engagement. Signs that a user is listening to a podcast during a particular commute also point to positive user engagement. The particular podcast listened to will have engagement metrics recorded and stored in the engagement metric database 146.

One example of location of consumption being used as an engagement metric is a user listening to a podcast during a lunch break at the user's work cubicle. The user may have established a routine in which a podcast providing news relating to the user's profession is listened to every day during lunch, in the same location of the user's work cubicle. The engagement module 128 receives information that a repeated location is consistently being reported for a particular podcast, and uses this as an indication of user engagement with respect to that podcast.

Another example is a user listening to a podcast during a commute to work every morning. In this example, the engagement module 128 opens a background location session while a user is playing back podcasts. The location session is capable of monitoring a route that a user takes while listening to any given podcast. The engagement module 128 may detect that a user is listening to a particular podcast in a repeated, consistent route during a particular time of day, such as between 8 AM and 9 AM on weekdays. In this way, the system can detect that the user has established a routine with respect to listening to that podcast, which indicates a particular user engagement with that podcast. The engagement module 128 thus records the user engagement metric accordingly.

A fourth engagement metric is user reviews and ratings. In some embodiments, a user will have the option of rating a particular podcast for perceived quality within the playback application on the user terminal 102. For example, a user may be able to give between zero and five stars to a podcast, representing the enjoyment of the user of the podcast's quality in relation to other podcasts. A high rating is sign of positive user enjoyment and engagement with respect to the podcast, and the engagement module 128 records this rating as such in an engagement metric which is stored in the engagement metric database 146. User reviews of podcasts are also signs of engagement, and the particular contents of reviews may signal positive or negative enjoyment of the podcast. In some embodiments, engagement module 128 conducts language processing on the contents of reviews to determine a positive or negative reaction by a user to a podcast. In some embodiments, the engagement module 128 takes into account the frequency of how often a user reviews podcasts, in order to provide an accurate ratio of consumption to reviews of consumed media.

One example of ratings working with respect to user engagement is a system and interface allowing for users to rate podcasts while they are listening. In some embodiments, the podcast application will periodically prompt the user to provide a rating between 0 and 5 stars for a podcast, either visually or through audio. In some embodiments, a user may provide a voice command to instantly express a rating to the system. In this way, the user is capable of rating dozens of podcasts, and may be rating podcasts on a daily basis. All of these ratings are captured within the engagement metrics database 146, and are factored into ranking as evidence of user engagement. In some embodiments, user-rated podcasts may automatically take engagement precedence over unrated podcasts when measuring how ratings indicate user engagement.

A fifth engagement metric is frequency of sharing and recommendation. In some embodiments, podcasts, podcast content packages, and links to podcasts may be shared, recommended or otherwise communicated to other users. Such communication may occur through email, social media, texting capabilities on a smart phone, or other means. In some embodiments, the engagement module 128 records the sharing of a podcast as a sign of user engagement and positive interaction with a podcast.

A sixth engagement metric is related document activity. In some embodiments, documents a user is working on that are related to a podcast that a user has listened to can be interpreted by engagement module 128 as a sign of positive engagement and interaction with the podcast. One example may be a worksheet PDF that is included in a podcast content package or is otherwise associated with the podcast. In some embodiments, the engagement module 128 performs machine learning techniques on the document to determine whether a connection can be made with a podcast. For example, a PDF or website containing a review of a podcast may contain language discussing a specific podcast episode and a description or recap of that episode. Through machine language processing, the engagement module 128 determines that the PDF or website is related to a specific podcast that user has engaged with, and indicates that this is a positive interaction with respect to that podcast.

Another example of related document activity may be social media postings. In some instances, a user may post to a social media website an opinion about a podcast that is in the user's library, or may post a video or other piece of content related to the podcast. Alternatively, a user may respond to a friend or follower's posting about a podcast in the user's library. A user may also simply “like”, follow, or otherwise express interest in a podcast on social media. In some embodiments, the engagement module 128 is capable of tracking this interest, with opt-in permission to track such social media information. The social media engagement thus translates to a way for podcasts to be ranked according to user engagement.

A seventh engagement metric is interacting with podcast details. In some embodiments, a user may interact with details, peripheral information and/or metadata associated with a podcast. Checking the description of a podcast, length of a podcast, searching for keywords within or about a podcast, and more may be used by the engagement module 128 as signs of positive interaction and engagement with the podcast.

In some embodiments, user engagement monitoring and sessions tracking interaction and engagement are continually performed in the background. Files associated with user engagement of podcasts are continually updated within the engagement database 146 as updates are detected. In other embodiments, user engagement sessions are periodically interrupted, or are only performed under optimal or satisfactory conditions, such as network conditions being sufficient for communicating information.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

A ranking module 130 is part of the podcast services engine 106. The ranking module 130 receives information about engagement metrics for a user's podcast library from the engagement database 146 and determines a ranking for podcasts based on those engagement metrics. In some embodiments, the podcasts to be ranked are limited in some way. For example, podcasts only listened to or otherwise interacted with in the past month or past two months may qualify for ranking. A set of ranking rules is received from ranking database 142. The ranking rules are a set of rules which are followed by the ranking module 130 to determine what forced ranking to give to podcasts relative to other podcasts. One or more engagement metrics may be specified within the ranking rules to be used in the ranking determination. A ranking is then stored within the ranking database 142. For example, ranking rules may specify that podcasts played by the user terminal 102 within the past month are to be ranked based on length of consumption, frequency of consumption, and user ratings. The specific formula for what weight is to be given to each of these engagement metrics is identified in the ranking rules. Podcasts A, B, and C may be ranked according to such metrics. The result of the ranking is stored in ranking database 142. In some embodiments, ranking information takes the form of numerical rankings of each podcast. In other embodiments, a ranking score is given to each podcast.

The podcast services engine 106 also includes an allocation module 132. The allocation module 132 receives ranking information from ranking database 142 for the respective podcasts that have been ranked, and also receives financial information from the user from the financial profile database 152. The financial profile information includes a total budget that has been allocated by the user to be spent on podcast donations. This total budget may represent a one-time budget, or may represent a budget for a recurring donation, to be spent at periodic interviews such as monthly. The allocation module 132 also retrieves a set of allocation rules from allocation database 144. When the allocation module 132 retrieves the budget a user is willing to spend, it interprets the allocation rules to decide upon how the budget is to be allocated given a ranking of the podcasts from the ranking database 142. Allocation rules may specify that a certain percentage of the total budget is to be given to each podcast based on its ranking and the total number of podcasts in the ranking. Allocation rules may contain formulas for determining allocation of budget based on ranking scores, with a weighting of the scores undertaken.

Upon allocating the budget based on rankings, the notification module 134 informs the user of the proposed allocation. Notifications are generated and sent to the user terminal 102. Notifications may be sent in the form of visual information, audio information or some other method. In some embodiments, the notification module 134 prompts the user to respond affirmatively or negatively to the allocation. Upon responding affirmatively, the allocation module 132 uses the user payment information from the user's financial profile to process payments to each podcast content provider to be allocated funds. The notification module 134 may then send a notification to the user that the payments have been successfully or unsuccessfully processed, and follow-up information or a receipt may be sent as well.

In some embodiments, the notification module 134 presents a set of statistics to the user. These statistics may take the form of a visual chart or graph and indicate a breakdown of the allocation of funds to podcasts. The statistics may also provide information on a user's playback of podcasts, locations and common routes for listening to podcasts, categories and kinds of podcasts, distinctions between commercial broadcasting and public nonprofit broadcasting, and more.

In some embodiments, the notification module 134 may also present statistics and information about incoming funds to one or more content providers. Anonymized donation information may be sent to providers in some embodiments. Users may elect to stay anonymous or reveal identities for the purposes of providing information to content providers. In varying embodiments, content providers may be shown information on where donations are coming from in terms of geographic location, from country level down to city level. Relevant demographics may also be shown to content providers. In some embodiments, demographic and location information is shown in aggregate rather than in terms of individual users. Content providers may also be shown trends in user engagement, and other information relating to how users are engaging and interaction with their podcasts.

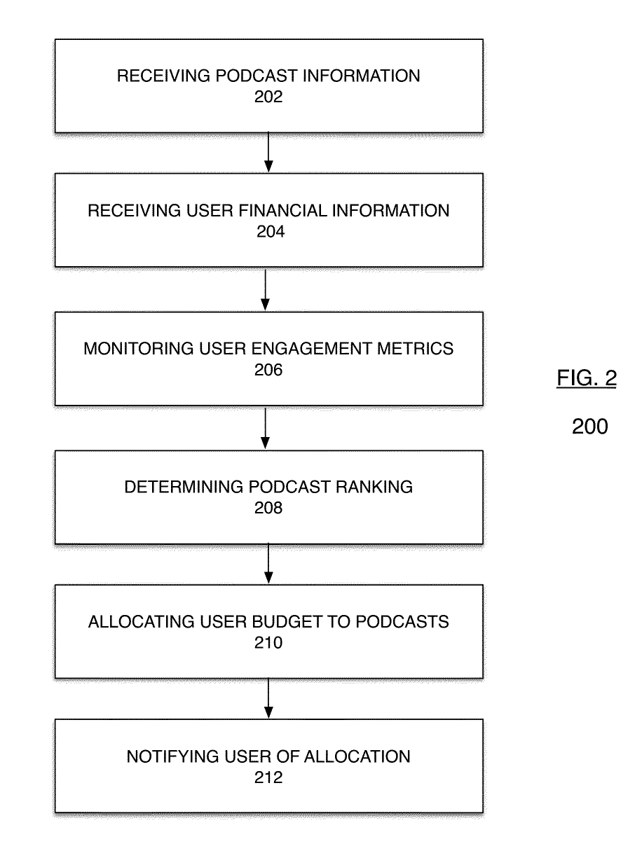

Turning now to FIG. 2, an operation of the engagement monitoring, ranking and allocation of the podcast services engine 106 will be discussed in greater detail. FIG. 2 is a flowchart of steps in an exemplary method 200 for determining the allocation of funds for podcast donations with respect to podcasts a user has listened to. For ease of illustration, the steps of method 200 will be described with respect to a server-centric configuration. That is, an embodiment, in which the engagement monitoring, ranking and allocation are performed on the server with respect to a user device. However, the steps shown in FIG. 2 can be carried in a substantially similar way in embodiments where some or all of the steps for engagement monitoring, ranking and allocation are performed at a user device, as described above. In one particular example, the monitoring of user engagement and activity in method 206 is performed entirely on the user device in some embodiments.

Method 200 begins at step 202, where the podcast services engine 106 receives podcast information for podcasts that a user has played back in some capacity on the user terminal 102. Podcast information consists of a list of podcasts, along with their names and identifying information, including content providers and source locations. This information is stored in the podcast database 140.

At step 204, user financial information is received. This includes payment information, including method of payment such as credit card or online payment service. This information is stored within the financial profile database 152 in a secure, encrypted matter, and is transferred to the podcast services engine 106 securely using a method that requires authentication and access restriction. This information also includes a total budget that a user is willing to spend, either as a one-time budget or a recurring budget. One example of a recurring budget is a monthly budget of $20 to be distributed to podcast content providers. The podcast services engine 106 is authorized by the user to process payments and transfer funds to content providers, either automatically or upon giving permission. A financial profile module 124 is also capable of adding new financial profile information, updating existing information, or deleting unwanted or expired financial profile information, upon a user's discretion. A user interface for modifying information is presented to the user for completing these tasks.

The user financial information received at step 204 is used to prepare a budget for additional steps within the method. Once a user specifies a total budget to be allocated or a recurring budget, that information can be retrieved from the financial profile database 152 by other modules to allocate a total budget to be spent on podcast donations, as well as individual monetary allocations for each podcast. In particular, the allocation module 132 retrieves financial information from the financial profile database 152. First it retrieves a total specified budget, either as a one-time budget or a recurring budget. Next, it apportions this budget to ranked podcasts according to the specific budget, dividing up the budget based on the ranking or ranking score.

In some embodiments, a user may specify how a budget may be allocated. Within an interface, a user may be prompted to enter information pertaining to a total budget to be allocated, as well as individual budgets to be allocated for one or more podcasts within the user's library. The user may also specify that some podcasts are not to be apportioned any donation amount during the allocation. In additional embodiments, a set of allocation rules may be created or customized by the user for dealing with allocation of budget with respect to podcasts. For example, a user may set up an allocation rule constraining the allocation module 132 to only allocate the budget to the top three podcasts within a ranking, regardless of the number of podcasts which have been engaged with. The allocation module 132 then follows this rule when allocating a donation amount to each podcast, by blocking the donation allocation to all but the top three podcasts within the ranking that has been established based on user engagement metrics. In this way, the user may have control over the narrow details of how donations are suggested by the system.

Another example of an allocation rule that a user may set up involves date range specifications for allocation. For example, a user may stipulate that only podcasts that have been engaged with in the past three months should be allocated an amount from the budget specified in the financial profile module 134. The allocation module 132 follows the rule set by the user accordingly, which potentially changes the amount of the budget that is allocated to the ranked podcasts.

At step 206, the engagement module 128 begins monitoring user engagement metrics. In some embodiments, the engagement module 128 opens up one or more background sessions for monitoring user activity. This may include processing of user inputs, processing passive listening and active listening, determining location of a user, and more. The engagement module 128 is capable of processing user engagement and activity at a constant low level while other tasks and steps within method 200 are performed. One or more of several possible engagement metrics are actively monitored, and the results of the engagement metrics for given podcasts are stored in the engagement metrics database 146. Examples of engagement metrics in differing embodiments include, as described above, length of consumption, frequency of consumption, location and route during consumption, user reviews and ratings, frequency of sharing and recommendation, documents relating to the podcasts, and how often details of the podcast are interacted with.

At step 208, the ranking module 130 determines a ranking of podcasts according to a set of ranking rules. The ranking rules are retrieved from ranking database 142. The podcasts to be ranked are determined by the ranking rules and may be constrained to, for example, the past month of user consumption. Ranking rules determine how the podcasts are to be ranked or scored, and take into account the engagement metrics that have been stored in the engagement metrics database 146. Rankings may either take the form of forced rankings relative to other podcasts, or ranking scores representing the level of user engagement and enjoyment of each podcast. The rankings and ranking scores are stored in ranking database 142.

Ranking rules may be any of a wide variety of rules which use the engagement metrics as a basis for ranking podcasts. Another example of a ranking rule relates to location of the user. A location ranking rule may specify that all users who have established a consistent morning commute for listening to podcasts should have the commute listening time count as a particularly important indicator of interest and engagement. The limitations of how this can be established may take a number of forms. In some embodiments, a GPS functionality within the system tracks the routes that a user takes during listening, and makes a note of routes that have repeated consistently or semi-consistently. These routes then factor in to the engagement metrics and count toward engagement with a podcast when they are detected.

Another example of a ranking rule involves the frequency of consumption. While some podcasts may be listened to by a user one or two times, other podcasts may be consumed weekly or even daily. The engagement module 128 is capable in some embodiments of tracking how often podcasts are listened to, and a ranking rule may specify that podcasts are to be ranked relative to each other based on the frequency of user playback of the podcasts.

Another example of a ranking rule involves ratings that a user provides with respect to podcasts. A ranking rule may specify that podcasts are to be ranked according to whether a user has voluntarily provided a rating to one or more podcasts to express enjoyment or lack thereof for the podcasts in question. Ratings may be built into the system interface as user input that can be entered as a user is listening to a podcast, for example.

While some ranking rules may stand on their own as capable of singlehandedly creating a ranking of podcasts, other ranking rules may be stacked upon each other or sequentially performed to create a ranking. For example, all three ranking rules used as examples above may be used in succession to form a ranking of podcasts by the ranking module 130. First location and route information is used by a ranking rule to sort the podcasts. Next, an iterative sorting of the podcasts is performed based on the frequency of consumption of each podcast. Finally, a further iterative sorting of the podcasts is performed based on the ratings of podcasts. The end result is a ranking that is created by three separate iterative sortings which further refine the ranking according to the three ranking rules specified.

In some embodiments, ranking rules may be adjusted, removed, or created by users. Within an interface for the podcast application, a ranking rules section may be found within a preferences section, which is operated by preferences module 126. In an embodiment in which ranking rules may be adjusted, the user may have the option to change how a ranking rule behaves, and how much weight it is given within the overall ranking. For example, although a user may decide that location and route are important to factor into the ranking of suggested donations, the user may nevertheless decide that only evening commutes should be factored into this determination of engagement. Further, the user may decide that location and route should be given less weight in determining a ranking than other ranking rules, including frequency of consumption and ratings for podcasts.

At step 210, the allocation module 132 allocates the user budget to the ranked podcasts. This is performed using the retrieved financial information from the user, the rankings or ranking scores from the ranking database 142, and allocation rules from allocation database 144. The allocation module 132 uses the allocation rules to allocation the user's budget according to the rankings or ranking scores. Specific fund amounts are assigned to each podcast according to the allocation.

At step 212, a user is notified about the allocation that has been determined, and given the option to proceed with the processing of payments according to the allocation. If the user agrees to proceed, then the allocation module 132 sends payments to content providers of podcasts, securely submitting user financial information through a financial system for paying authorized content providers. A user is then notified upon processing of payments. In some embodiments, the user receives a visual notification of allocation and user engagement in chart or graph form. In some embodiments, the content provider receives anonymized or aggregated statistics regarding demographics, user engagement, location and other information pertaining to users who have sent financial contributions.

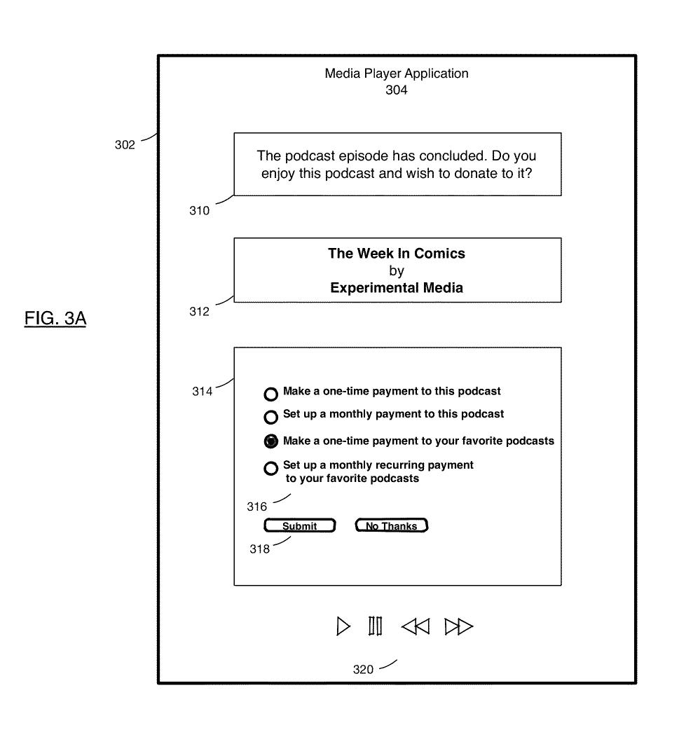

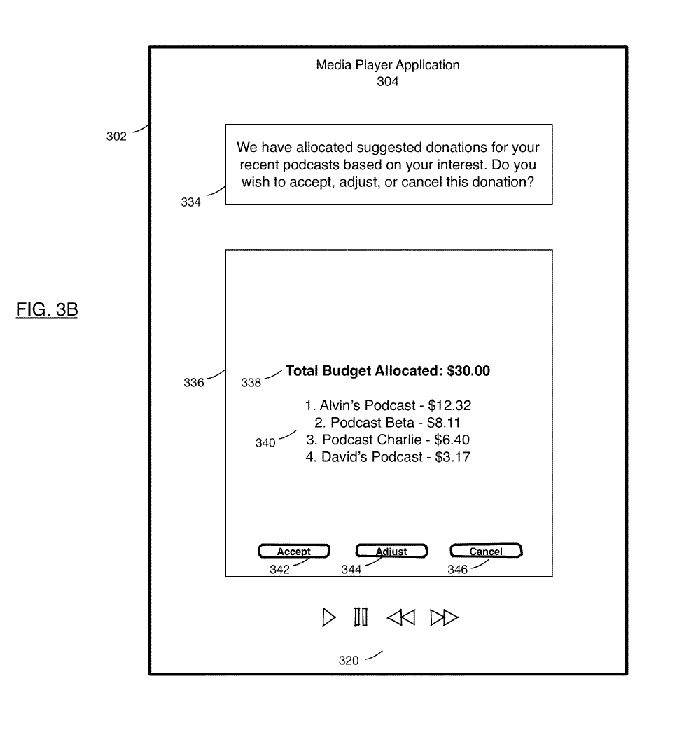

FIG. 3A and FIG. 3B illustrate exemplary interface embodiments presented on a user device. The more appropriate embodiment will be apparent to those of ordinary skill in the art when practicing the present technology. Persons of ordinary skill in the art will also readily appreciate that other interface embodiments are possible.

FIG. 3A illustrates an exemplary embodiment of a donation message presentation on a user's device. User device 302 is presented in this embodiment as a tablet device which a user is operating the podcast application on. Other embodiments may present the donation interface on a desktop computer, laptop computer, phone, car stereo device, or similar.

The media player application 304 is a software application which is executed on the user device 302 and allows for the playback and management of podcast media content. In the exemplary embodiment, the media player application 304 takes the form of a podcast application which allows a user to retrieve, organize, and consume podcasts. In some embodiments, the media player application 304 is capable of retrieving new podcast episodes on a recurring basis for efficiency and ease of use. The media player application 304 displays an interface which a user can interact with in retrieving podcasts, selecting them for playback, editing preferences and more. The media player application interface also allows for a user to make donations to podcasts based on the user's engagement with those podcasts, which FIG. 3A illustrates a portion of.

We turn now to an example of an interface screen which queries the user regarding potential donations. Although the interface in FIG. 3A is presented as a visual interface with visual messages and user input, it should be understood that possible embodiments may take other forms. For example, the messages shown or other messages may be presented through audio, whether through playback of prerecorded messages, a generated voice from the podcast application or from the operating system of the user device, or some other audio form. In addition, user input may take the form of voice commands, gestures, or other input outside of tactile interaction with visual input choices.

Through message window 310 the embodiment illustrates a notification to a user that the podcast playback has concluded for a particular podcast, and that there is an option presented to donate to the podcast if the user has enjoyed it. In the exemplary embodiment this is presented in a simple, unobtrusive way for a user to engage with or decline to engage with. A message box within the interface shows the notification. In some embodiments, passive or inactive engagement with this notification screen for a set period of time leads to the interface moving on to a different aspect of the podcast application, such as playback of another podcast. In some embodiments, the message window 310 may inform the user of a podcast currently running, a podcast that has just been started, or a podcast that is up next in a queue.

The message window 312 notifies the user of the podcast that has just ended, which the potential donation pertains to. This serves as a reminder to the user of the podcast that has just concluded. It notifies the user of not only the name of the podcast, but also the content producer involved in creating or distributing the podcast content. In some embodiments, the message window 312 further depicts additional details of the podcast, such as the podcast episode number, length, and other details. In some embodiments, a sponsor's name may appear in addition to or in place of the content provider's name.

The message window 314 allows the user to make a selection from a variety of donation options, represented by 316. In the exemplary embodiment presented in FIG. 3A, the donation options 316 are four visual radio buttons which can be checked or unchecked, presenting four different donation options. The first option, “Make a one time payment to this podcast,” allows for the user to make a single, non-recurring payment to the providers of the podcast that has concluded. The second option, “Set up a monthly payment to this podcast,” configures a donation to be sent to the podcast's content providers once every month. The details of the recurring payment and can be modified upon submitting this option. The third option, “Make a one-time payment to your favorite podcasts,” allows the user to make a single, non-recurring payment to a number of podcasts based on user engagement and interaction with podcasts within the user's library. The fourth option, “Set up a monthly recurring payment to your favorite podcasts,” configures a donation to be sent once a month to the user's favorite podcasts, determined by the user's engagement and interaction with podcasts in the user's library. The third and fourth options presented both lead to the exemplary method of apportioning the user's allocated budget to podcasts based on engagement that is monitored and assessed.

While these four options are exemplary of options that a typical user is presented with in decided whether to make a donation to a podcast or podcasts, other options may be presented to the user in differing embodiments. For example, an additional option may allow the user to manually allocate a one-time payment to one or more of a set of podcasts that the user personally selects, without using the engagement metrics. Another option may be to present one or more sponsored podcasts to donate to as part of a promotion or marketing campaign. Any variation on donating to a podcast or set of podcasts may be contemplated for inclusion in the set of options presented to the user in message window 314.

Once the user selects one of the options 316, the user may then click on a submit button in 318, or click on a button to cancel the donation. Cancelling the donation leads to the user interface displaying another aspect of the podcast application or playing a new podcast. In some embodiments, cancelling the donation is tracked within the system as an indication that the user wishes to avoid donations in the future. A user clicking on the submit button leads in some embodiments to an additional page for allocating a budget, date(s) of payment, and more. In some embodiments, clicking the submit button leads to the media application presenting the user with a set of ranked podcasts which represent the podcasts which are apportioned donations.

At any time, playback buttons 320 may be engaged with by the user to play a new podcast episode, skip to a new episode, pause a currently running podcast, or otherwise navigate through the playback options. In some embodiments, the donation suggestions disappear upon the user engaging with a playback button. In other embodiments, the donation suggestions remain active while a user engages with the playback buttons 320.

Turning now to FIG. 3B, an exemplary embodiment of a budget allocation screen within an interface of the present system is illustrated. As in FIG. 3A, user device 302 is presented in this embodiment as a tablet device which a user is operating the podcast application on. Other embodiments may present the donation interface on a desktop computer, laptop computer, phone, car stereo device, or similar. A media player application 304 as described above is also present on the user device, displaying the interface and user options and allowing for playback and selection of podcasts.

FIG. 3B is an example interface screen that is presented once a user has selected in a previous screen, such as that depicted in FIG. 3A, that the user wishes to donate an allocated amount to one or more podcasts according to the user's engagement in podcasts within the user's library. The user in this example interface has also previously specified the amount of budget to be allocated from the user's funds. Other embodiments may shift the flow of information and user selections into any order that suits the particular interface desired. In some embodiments, a suggested donation amount is presented by the system without the user allocating a budget to spend.

Message window 334 presents a notification to the user that suggested donations have been allocated based on the interests of the user and their engagement metrics representing those interests. The message window 334 further prompts the user to select whether the user accepts the suggested donation, wishes to adjust the suggested donation, or wishes to cancel the donation. Other prompts and notifications may be presented in differing embodiments.

Message window 336 presents a notification to the user of the allocated budgets and options which the user may select regarding the donation. The total allocated budget 338 is displayed within the message window 336. In an exemplary embodiment, the budget allocated may be determined from a previous screen of the interface in which the user specifies an amount to donate. In some embodiments, the total budget allocated is a suggested amount that is determined by the content provider, the media player application, or a sponsor. In some embodiments, the total budget allocated is determined by the user engagement with podcasts within the library. For example, a user who overall does not engage with much podcast content may be presented with a smaller allocated budget than a user who engages with podcast content on a frequent, daily basis. In some embodiments, information about the total budget allocated may be obtained from the financial profile module 124, which may contain such stored information from the user as the amount to allocate in future donations.

At 340, a ranking or listing of podcasts which have been allocated donation amounts from the budget is presented. The ranked podcasts are determined according to the ranking module 130, which receives information about the user's engagement activity and ranks the podcasts within the user's library accordingly. The amounts that are assigned to each ranking podcast are determined by the allocation module 132, which receives information from the ranking module 130 as well as financial information from the financial profile module 124 in order to determine the proper allocated amount for the ranked podcast. The amount of each individual allocated amount adds up to the total allocated budget 338. In some embodiments, a listing or ranking can be replaced with a graph or chart, such as a pie chart visually representing the amount each podcast is allocated to receive. Several depictions of the budget allocated to podcasts are possible. In some embodiments, no ranking or order is displayed for users when listing the podcasts. In some embodiments, the amount allocated to each podcast is not displayed.

In some embodiments, a user is shown not only rankings and allocated donations, but also user engagement metrics for those podcasts, such as amount of time spent listening to each, ratings the user has assigned to each podcast, and more. Notifying a user of the user's enjoyment, engagement and activity with respect to podcasts may present a more transparent understanding to the user of how the user's favorite podcasts are determined. In some embodiments, the amount of information that is shown to a user can be customized and adjusted within a preferenced module 126.

Below the message window 340, the exemplary embodiment shows buttons 342 for accepting the suggested donation, 344 for adjusting the suggested donation, and 346 for canceling the donation. If the user clicks on the 342 submit button, the interface moves to a screen in which the user can see a final checkout or payment notification prior to the payment being processed and sent to the content provider of the podcast. In some embodiments, the user may have an opportunity to confirm the payment method and billing address, or enter new financial information prior to the payment processing. In some embodiments, the user may have the option to send messages of support to the content provider or providers along with the payments. Such messages of support would then be sent to the content providers in a notification along with the payment information.

If a user clicks on the 344 adjust button, then the user has the opportunity to adjust various parts of the ranking and donation allocation to the user's preferences. The user may be given the option to add additional podcasts which are not displayed within the listing and which have not been denoted for donation by the ranking module 130. The user may also have the option to block certain podcasts in the ranking from receiving a payment. In some embodiments, the user may permanently block a podcast from being suggested for donations. Some embodiments may additionally allow the user to adjust the monetary amounts of any of the allocated payments for podcasts. The user may also adjust the total budget allocated, and in some embodiments the donations allocated for each ranked podcast will automatically adjust according to the newly entered budget.

If a user clicks on the 346 cancel button, the interface may lead to another aspect of the media player application, or may begin playing a new podcast. In some embodiments, the interface will confirm that the user wishes to cancel the donation. In some embodiments, cancelling the donation will be tracked within the system as an indication that the user wishes to avoid donations in the future.

As in FIG. 3A, playback buttons 320 may be engaged with by the user at any time to control playback and selection of podcast content. In some embodiments, playback of a new podcast item will cancel the donation screen. In other embodiments, playback can occur while the donation screen remains open.

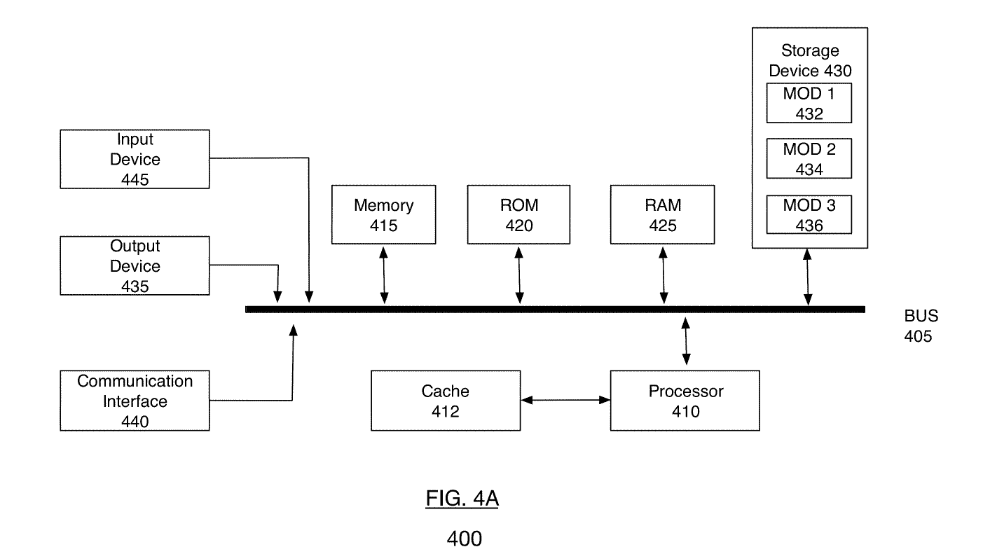

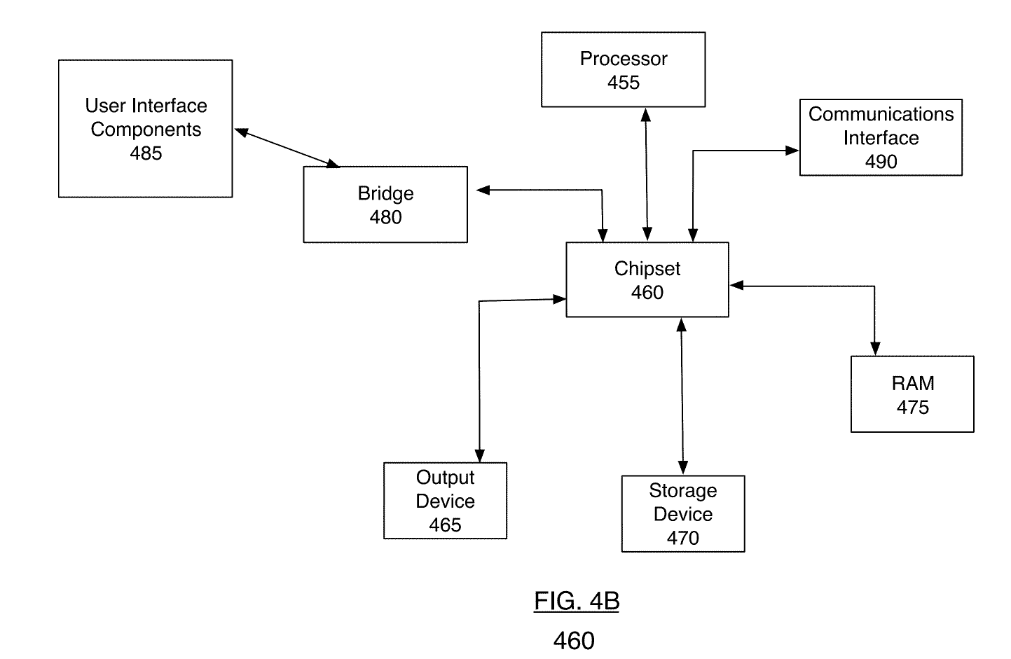

FIG. 4A, and FIG. 4B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 4A illustrates a conventional system bus computing system architecture 400 wherein the components of the system are in electrical communication with each other using a bus 405. Exemplary system 400 includes a processing unit (CPU or processor) 410 and a system bus 405 that couples various system components including the system memory 415, such as read only memory (ROM) 420 and random access memory (RAM) 425, to the processor 410. The system 400 can include a cache of high-speed memory connected directly with, in close proximity to, or integrated as part of the processor 410. The system 400 can copy data from the memory 415 and/or the storage device 430 to the cache 412 for quick access by the processor 410. In this way, the cache can provide a performance boost that avoids processor 410 delays while waiting for data. These and other modules can control or be configured to control the processor 410 to perform various actions. Other system memory 415 may be available for use as well. The memory 415 can include multiple different types of memory with different performance characteristics. The processor 410 can include any general purpose processor and a hardware module or software module, such as module 1 432, module 2 434, and module 3 436 stored in storage device 430, configured to control the processor 410 as well as a special-purpose processor where software instructions are incorporated into the actual processor design. The processor 410 may essentially be a completely self-contained computing system, containing multiple cores or processors, a bus, memory controller, cache, etc. A multi-core processor may be symmetric or asymmetric.

To enable user interaction with the computing device 400, an input device 445 can represent any number of input mechanisms, such as a microphone for speech, a touch-sensitive screen for gesture or graphical input, keyboard, mouse, motion input, speech and so forth. An output device 435 can also be one or more of a number of output mechanisms known to those of skill in the art. In some instances, multimodal systems can enable a user to provide multiple types of input to communicate with the computing device 400. The communications interface 440 can generally govern and manage the user input and system output. There is no restriction on operating on any particular hardware arrangement and therefore the basic features here may easily be substituted for improved hardware or firmware arrangements as they are developed.

Storage device 430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 425, read only memory (ROM) 420, and hybrids thereof.

The storage device 430 can include software modules 432, 434, 436 for controlling the processor 410. Other hardware or software modules are contemplated. The storage device 430 can be connected to the system bus 405. In one aspect, a hardware module that performs a particular function can include the software component stored in a computer-readable medium in connection with the necessary hardware components, such as the processor 410, bus 405, display 435, and so forth, to carry out the function.

FIG. 4B illustrates a computer system 450 having a chipset architecture that can be used in executing the described method and generating and displaying a graphical user interface (GUI). Computer system 450 is an example of computer hardware, software, and firmware that can be used to implement the disclosed technology. System 450 can include a processor 455, representative of any number of physically and/or logically distinct resources capable of executing software, firmware, and hardware configured to perform identified computations. Processor 455 can communicate with a chipset 460 that can control input to and output from processor 455. In this example, chipset 460 outputs information to output 465, such as a display, and can read and write information to storage device 470, which can include magnetic media, and solid state media, for example. Chipset 460 can also read data from and write data to RAM 475. A bridge 480 for interfacing with a variety of user interface components 485 can be provided for interfacing with chipset 460. Such user interface components 485 can include a keyboard, a microphone, touch detection and processing circuitry, a pointing device, such as a mouse, and so on. In general, inputs to system 450 can come from any of a variety of sources, machine generated and/or human generated.

Chipset 460 can also interface with one or more communication interfaces 490 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 455 analyzing data stored in storage 470 or 475. Further, the machine can receive inputs from a user via user interface components 485 and execute appropriate functions, such as browsing functions by interpreting these inputs using processor 455.

It can be appreciated that exemplary systems 400 and 450 can have more than one processor 410 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures. Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer implemented method, comprising:
receiving a list of podcasts and a donation budget from a user;
monitoring, via an engagement engine, one or more engagement metrics corresponding to each of the podcasts, wherein the one or more engagement metrics indicate user activity with respect to a podcast;
determining, via a ranking engine, a ranking for the list of podcasts according to the one or more engagement metrics; and
allocating, via an allocation engine, the donation budget to the podcast, wherein each podcast is allocated a portion of the donation budget according to its ranking.

2. The computer implemented method of claim 1, further comprising:
sending, via a notification engine, a notification to the user device regarding the allocation of the donation budget.

3. The computer implemented method of claim 1, wherein the one or more engagement metrics comprise amount of a podcast consumed by the user.

4. The computer implemented method of claim 1, wherein the one or more engagement metrics comprise at least one of location and route of the user during consumption of a podcast by the user.

5. The computer implemented method of claim 1, further comprising:
processing a payment from the user according to the allocated donation budget.

6. The computer implemented method of claim 1, wherein the allocation of the donation budget to the podcast is performed on a recurring period basis.

7. The computer implemented method of claim 1, wherein the determining a ranking is performed by determining a positive or negative engagement of the user to each of the podcasts according to the engagement metrics.

8. The computer implemented method of claim 1, wherein the engagement metrics of the user for a podcast is determined according to whether the engagement metrics indicate a positive or negative interaction with the podcast.

9. A computer-readable medium storing computer executable instructions for causing a computer to perform the method comprising:
receiving a list of podcasts and a donation budget from a user;
monitoring, via an engagement engine, one or more engagement metrics corresponding to each of the podcasts, wherein the one or more engagement metrics indicate user activity with respect to a podcast;
determining, via a ranking engine, a ranking for the list of podcasts according to the one or more engagement metrics; and
allocating, via an allocation engine, the donation budget to the podcasts, wherein each podcast is allocated a portion of the donation budget according to its ranking.

10. The computer-readable medium of claim 9, further comprising:
sending, via a notification engine, a notification to the user device regarding the allocation of the donation budget.

11. The computer-readable medium of claim 9, wherein the allocation of the donation budget to the podcasts is performed on a recurring period basis.

12. The computer-readable medium of claim 9, wherein the determining a ranking is performed by determining a positive or negative engagement of the user to each of the podcasts according to the engagement metrics.

13. The computer-readable medium of claim 9, wherein the engagement metrics of the user for a podcast is determined according to whether the engagement metrics indicate a positive or negative interaction with the podcast.

14. The computer-readable medium of claim 9, further comprising:
sending, via a provider notification engine, user information to a content provider of a podcast regarding the user after a portion of the donation budget has been allocated to the podcast.

15. The computer-readable medium of claim 14, wherein the user information comprises at least one of demographic information, location information, and engagement metrics of the user.

16. A product comprising:
a computer readable medium; and
computer readable instructions, stored on the computer readable medium, that when executed are effective to cause a computer to:
receive a list of podcasts and a donation budget from a user;
monitor, via an engagement engine, one or more engagement metrics corresponding to each of the podcasts, wherein the one or more engagement metrics indicate user activity with respect to a podcast;
determine, via a ranking engine, a ranking for the list of podcasts according to the one or more engagement metrics; and
allocate, via an allocation engine, the donation budget to the podcasts, wherein each podcast is allocated a portion of the donation budget according to its ranking.

17. The product of claim 16, further comprising:
sending, via a notification engine, a notification to the user device regarding the allocation of the donation budget.

18. The product of claim 16, wherein the allocation of the donation budget to the podcasts is performed on a recurring period basis.

19. A computer implemented method, comprising:
receiving a list of podcasts and a donation budget from a user;
monitoring, via an engagement engine, one or more engagement metrics corresponding to each of the podcasts, wherein the one or more engagement metrics indicate user activity with respect to a podcast;
determining, via a ranking engine, a ranking for the list of podcasts according to the one or more engagement metrics; and
allocating, via an allocation engine, the donation budget to the podcasts, wherein each podcast is allocated a portion of the donation budget according to its ranking.
sending, via a notification engine, a notification to the user device regarding the allocation of the donation budget.

20. The computer implemented method of claim 19, wherein the one or more engagement metrics comprise at least one of length of consumption, frequency of consumption, and location of the user.

21. The computer implemented method of claim 19, wherein the determining a ranking is performed by determining a positive or negative engagement of the user to each of the podcasts according to the engagement metrics.

22. The computer implemented method of claim 19, wherein the engagement metrics of the user for a podcast is determined according to whether the engagement metrics indicate a positive or negative interaction with the podcast.

23. The computer implemented method of claim 1, further comprising:
displaying, via a statistics engine, a visual notification of user engagement and budget allocation for the podcasts, consisting of at least one of a chart, a graph or other visual marker.
